(19) United States
(12) Patent Application Publication
(10) Pub. No.: US 2014/0159684 A1
(43) Pub. Date: Jun. 12, 2014

(54) BUCK POWER CONVERTER

(71) Applicant: EXCELLIANCE MOS CORPORATION, Hsinchu County (TW)

(72) Inventors: Pao-Chuan Lin, Hsinchu County (TW); Su-Yuan Lin, Hsinchu County (TW); Hung-Che Chou, Hsinchu County (TW)

(73) Assignee: EXCELLIANCE MOS CORPORATION, Hsinchu County (TW)

(21) Appl. No.: 13/711,625

(22) Filed: Dec. 12, 2012

(51) Int. Cl. G05F 1/10

(52) U.S. Cl. CPC G05F 1/10
USPC 323/282

(57) ABSTRACT

A buck power converter includes a power transistor, an inductor, a first diode, and an anti-ringing circuit. The power transistor has a first terminal, a second terminal, and a control terminal. The first terminal of the power transistor receives an input voltage, and the control terminal of the power transistor receives a pulse width modulation (PWM) signal. The anti-ringing circuit detects a detection voltage on the second terminal of the power transistor. According to the detection voltage, the anti-ringing circuit provides at least one second diode serially coupled between the second terminal of the power transistor and a reference ground terminal in a forward-biased manner, so as to clamp a voltage swing of the detection voltage.

### BACKGROUND OF THE INVENTION

1. Field of Invention

This invention relates to a buck power converter, and more particularly to a buck power converter capable of achieving an anti-ringing effect.

2. Description of Related Art

FIG. 1 illustrates circuitry of a conventional buck power converter 100. The buck power converter 100 includes a power transistor Q1, a diode D1, an inductor L1, and capacitors C1 and C2, and the buck power converter 100 generates an output voltage VOUT according to an input voltage VIN received by the buck power converter 100, so as to drive a load RL.

The power transistor Q1 is switched on or off according to a pulse width modulation signal PWM received by the power transistor Q1. In the process of switching on or off the power transistor Q1, the buck power converter 100 transmits a current from an input terminal IN that receives the input voltage VIN to an output terminal OUT of the buck power converter 100. When the power transistor Q1 is switched on, a voltage difference at two terminals of the inductor L1 is obtained by subtracting the output voltage VOUT from the input voltage VIN (the voltage difference=VIN−VOUT), the current flows from the input terminal IN to the output terminal OUT through the power transistor Q1, and the current is increased along with time at a speed that may be calculated through (VIN-VOUT)/L1, wherein VIN is the input voltage, VOUT is the output voltage, and L1 is the inductance of the inductor L1.

By contrast, when the power transistor Q1 is switched off, a current loop is generated through the diode D1. Here, the voltage difference at the two terminals of the inductor L1 is changed to −(VOUT+VD), wherein VD stands for a swing voltage VD on the diode D1; the current flowing through the inductor L1 is reduced along with time at a speed which may be calculated through (VOUT+VD)/L1, wherein VD stands for the swing voltage VD on the diode D1, and L1 is the inductance of the inductor L1. If the load RL herein refers to a light load, the buck power converter 100 enters a discontinuous-conduction mode (DCM). After the current on the inductor L1 is gradually reduced to 0, the voltage VB on a terminal where the power transistor Q1 and the inductor L1 are coupled may encounter the ringing issue; thus generating unnecessary noise.

### SUMMARY OF THE INVENTION

The invention is directed to a buck power converter capable of effectively resolving a ringing issue which may occur in a power transistor when the buck power converter is in a light-load mode.

In an embodiment of the invention, a buck power converter that including a power transistor, an inductor, a first diode, and an anti-ringing circuit is provided. The power transistor has a first terminal, a second terminal, and a control terminal. The first terminal of the power transistor receives an input voltage, and the control terminal of the power transistor receives a pulse width modulation (PWM) signal. The inductor is serially coupled between the second terminal of the power transistor and an output terminal of the buck power converter. A cathode of the first diode is coupled to the second terminal of the power transistor, and an anode of the first diode is coupled to a reference ground terminal. The anti-ringing circuit is coupled between the second terminal of the power transistor and the reference ground terminal. Here, the anti-ringing circuit detects a detection voltage on the second terminal of the power transistor and provides at least one second diode to be serially coupled between the second terminal of the power transistor and the reference ground terminal in a forward-biased manner according to the detection voltage, so as to clamp a voltage swing of the detection voltage.

According to an embodiment of the invention, when the anti-ringing circuit calculates and determines that a current flowing through the inductor has an absolute value smaller than a threshold value according to the detection voltage, the anti-ringing circuit provides the second diode that is serially coupled between the second terminal of the power transistor and the reference ground terminal in the forward-biased manner.

According to an embodiment of the invention, when the anti-ringing circuit calculates and determines that a current flowing through the inductor is equal to 0 according to the detection voltage, the anti-ringing circuit provides the second diode which is serially coupled between the second terminal of the power transistor and the reference ground terminal in the forward-biased manner.

According to an embodiment of the invention, the anti-ringing circuit further includes a switch and a control circuit. A first terminal of the switch is coupled to the second terminal of the power transistor, a second terminal of the switch is coupled to an anode of the second diode, and a control terminal of the switch receives a control signal and is switched on or off according to the control signal. The control circuit is coupled to the control terminal of the switch and the second terminal of the power transistor. According to the detection voltage, the control circuit generates the control signal.

According to an embodiment of the invention, the control circuit calculates and determines whether a current flowing through the inductor has an absolute value smaller than a threshold value according to the detection voltage, so as to generate the control signal.

According to an embodiment of the invention, when the control circuit calculates and determines that the current flowing through the inductor has the absolute value smaller than the threshold value according to the detection voltage, the control circuit generates the control signal to switch on the switch.

According to an embodiment of the invention, the buck power converter further includes a capacitor, one terminal of the capacitor is coupled to the cathode of the first diode, and the other terminal of the capacitor is coupled to the anode of the first diode.

According to an embodiment of the invention, the buck power converter further includes a voltage regulating capacitor which is serially coupled between an output terminal of the power transistor and the reference ground terminal.

In view of the above, the anti-ringing circuit is provided to calculate and determine the current flowing through the inductor according to the detection voltage on the second terminal of the power transistor. Besides, by way of providing the diode coupled to the second terminal of the power transistor, the anti-ringing circuit is able to clamp a voltage swing of the detection voltage. Thereby, it is likely to resolve the ringing issue which may occur when the buck power converter is in a light-load mode, and the noise that may be generated in the buck power converter is reduced.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates circuitry of a conventional buck power converter 100.

FIG. 2 is a schematic view illustrating a buck power converter 200 according to an embodiment of the invention.

FIG. 3A is a schematic view illustrating a buck power converter 300 according to another embodiment of the invention.

FIG. 3B schematically illustrate parts of circuitry of an anti-ringing circuit 310 according to an embodiment of the invention.

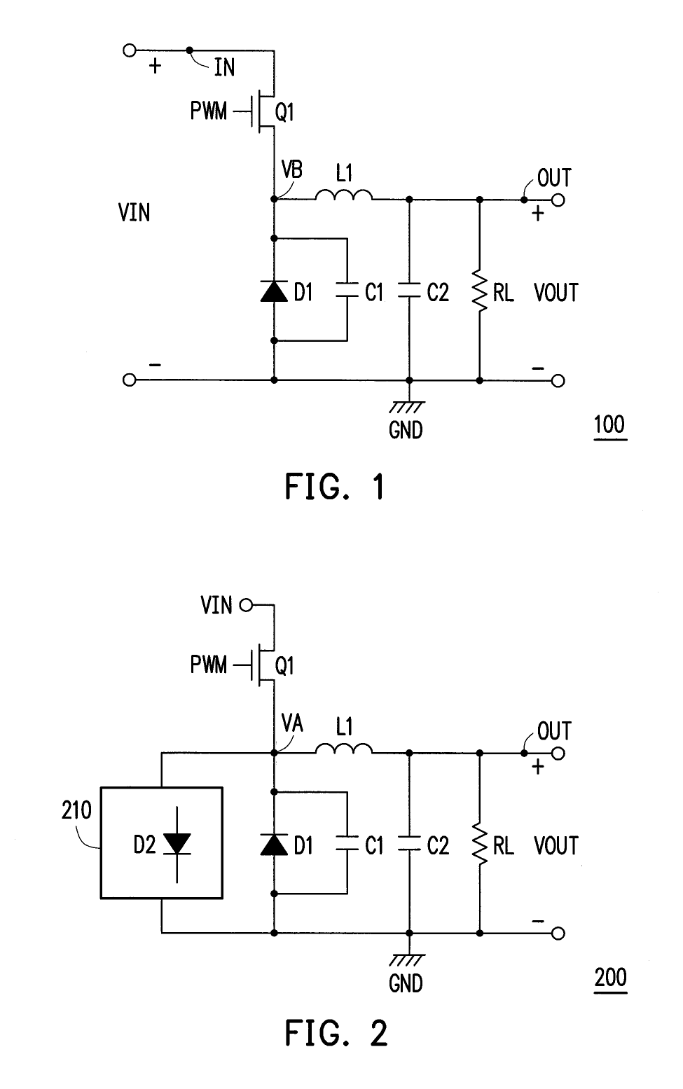

### DETAILED DESCRIPTION OF DISCLOSED EMBODIMENTS

Please refer to FIG. 2, which schematically illustrates a buck power converter 200 according to an embodiment of the invention. The buck power converter 200 includes a power transistor Q1, an inductor L1, a diode D1, and an anti-ringing circuit 210. The power transistor Q1 has a first terminal (e.g. a source), a second terminal (e.g. a drain), and a control terminal (e.g. a gate). The first terminal of the power transistor Q1 receives an input voltage VIN, and the control terminal of the power transistor Q1 receives a pulse width modulation signal PWM. According to the pulse width modulation signal, the power transistor Q1 is switched on or off. The second terminal of the power transistor Q1 is coupled to one terminal of the inductor L1, and the other terminal of the inductor L1 is coupled to an output terminal OUT of the buck power converter 200, so as to generate an output voltage VOUT.

The diode D1 is serially coupled between the second terminal of the power transistor Q1 and the reference ground terminal GND. Here, an anode of the diode D1 is coupled to a reference ground terminal GND, and a cathode of the diode D1 is coupled to the second terminal of the power transistor Q1 and coupled to the inductor L1.

The anti-ringing circuit 210 is coupled between the second terminal of the power transistor Q1 and the reference ground terminal GND. The anti-ringing circuit 210 detects a detection voltage VA on the second terminal of the power transistor Q1. According to the detection voltage VA, the anti-ringing circuit 210 provides a diode D2 that is coupled between the second terminal of the power transistor Q1 and the reference ground terminal GND in a forward-biased manner, so as to clamp a voltage swing of the detection voltage VA.

To be more specific, the anti-ringing circuit 210 may calculate and determine whether a current flowing through the inductor L1 is equal to 0 according to the detection voltage VA; if yes, the anti-ringing circuit 210 provides the diode D2 that is serially coupled between the second terminal of the power transistor Q1 and the reference ground terminal GND in the forward-biased manner, so as to clamp the voltage swing of the detection voltage VA and restrain the ringing phenomenon caused by the detection voltage VA. When the anti-ringing circuit 210 is actually operated, the anti-ringing circuit 210 calculates and determines whether the current flowing through the inductor L1 has an absolute value smaller than a threshold value according to the detection voltage VA; if yes, the anti-ringing circuit 210 provides the diode D2 that is serially coupled between the second terminal of the power transistor Q1 and the reference ground terminal GND.

The threshold value may approach and may be slightly greater than 0. According to the actual condition of the circuitry, a designer may set up the threshold value in advance.

Additionally, in the present embodiment, the buck power converter 200 further includes a capacitor C1 and a voltage regulating capacitor C2. The capacitor C1 is connected to the diode D1 in parallel, and the voltage regulating capacitor C2 is serially coupled to the terminal of the inductor L1 that is not coupled to the second terminal of the power transistor Q1. The output terminal OUT of the buck power converter 200 converts the input voltage VIN to generate the output voltage VOUT and to further drive a load RL.

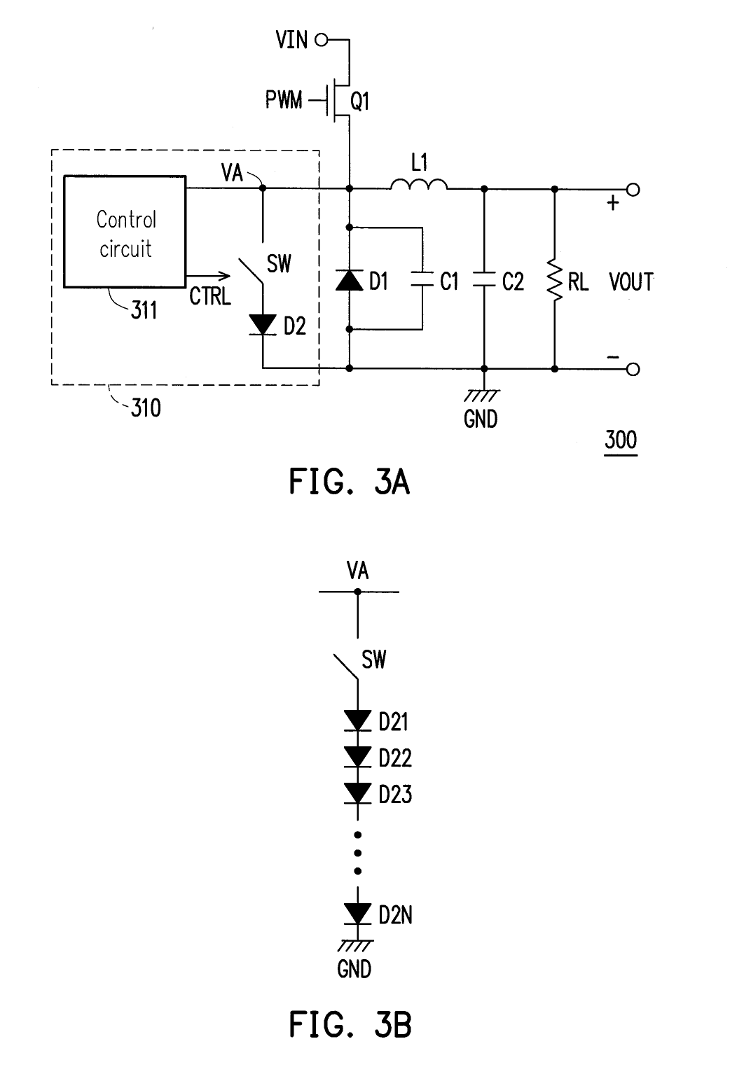

FIG. 3A is a schematic view illustrating a buck power converter 300 according to another embodiment of the invention. The buck power converter 300 includes a power transistor Q1, an inductor L1, a diode D1, a capacitor C1, a voltage regulating capacitor C2, and an anti-ringing circuit 310. According to the present embodiment, the anti-ringing circuit 310 includes a switch SW and a control circuit 311. A first terminal of the switch SW is coupled to a second terminal of the power transistor Q1. A second terminal of the switch SW is coupled to an anode of a diode D2. A control terminal of the switch SW receives a control signal CTRL and is switched on or off according to the control signal CTRL.

The control circuit 311 is coupled to the control terminal of the switch SW and the second terminal of the power transistor Q1, and the control circuit generates the control signal CTRL according to the detection voltage VA. Specifically, the control circuit 311 detects the detection voltage on the second terminal of the power transistor Q1; according to the detection voltage, the control circuit 311 calculates and determines the absolute value of the current flowing through the inductor L1. When the control circuit 311 calculates and determines that the current flowing through the inductor L1 has the absolute value that is equal to 0 (or smaller than a threshold value), the control circuit 311 switches on the switch SW according to the control signal CTRL generated by the control circuit 311. Thereby, the diode D2 is serially coupled between the second terminal of the power transistor Q1 and the reference ground terminal GND in a forward-biased manner. Through said diode D2, the voltage swing of the detection voltage VA may be effectively clamped, and thereby the possible ringing phenomenon may be effectively restrained.

Through the comparison between the detection voltage VA and a target voltage, the control circuit 310 is able to calculate and determine whether the current flowing through the inductor L1 has the absolute value equal to or close to 0. The aforesaid target voltage may be the detection voltage deduced from the circuit theory when the current flowing through the inductor L1 has the absolution value equal to 0.

Note that the diode D2 may be replaced by a plurality of serially connected diodes. FIG. 3B schematically illustrate parts of circuitry of an anti-ringing circuit 310 according to an embodiment of the invention. According to the present embodiment, diodes D21 to D2N are sequentially and serially coupled between the switch SW and the reference ground terminal GND in a forward-biased manner.

The number of the diodes D21 to D2N may be determined according to the detection voltage VA and threshold voltages of the diodes D21 to D2N. When the current flowing through the inductor L1 has the absolute value equal to 0, a designer may, based on the detection voltage VA, calculate the required number of diodes D21 to D2N.

To sum up, in an embodiment of the invention, the detection voltage on a connection terminal where the power transistor and the inductor are coupled is detected to learn whether the current flowing through the inductor has the absolute value equal to 0; thereby, the diode serially coupled between said connection terminal and the reference ground terminal in the forward-biased manner may be provided to further clamp the voltage swing of the detection voltage. As such, the ringing phenomenon that may occur when the buck power converter is in a light-load mode can be prevented to a better extent, and the resultant noise may then be reduced. In addition, the diode may be applied to achieve the anti-ringing effect. Specifically, since the diode may be rapidly switched on and may have low resistance, the ringing phenomenon that may occur in the buck power converter is likely to be restrained quickly.

Although the invention has been described with reference to the embodiments thereof, it will be apparent to one of the ordinary skills in the art that modifications to the described embodiments may be made without departing from the spirit of the invention. Accordingly, the scope of the invention will be defined by the attached claims not by the above detailed description.

What is claimed is:

1. A buck power converter comprising:
a power transistor having a first terminal, a second terminal, and a control terminal, the first terminal of the power transistor receiving an input voltage, the control terminal of the power transistor receiving a pulse width modulation signal;
an inductor serially coupled between the second terminal of the power transistor and an output terminal of the buck power converter;
a first diode, a cathode of the first diode being coupled to the second terminal of the power transistor, and an anode of the first diode being coupled to a reference ground terminal; and
an anti-ringing circuit coupled between the second terminal of the power transistor and the reference ground terminal, the anti-ringing circuit detecting a detection voltage on the second terminal of the power transistor and the anti-ringing circuit providing at least one second diode to be serially coupled between the second terminal of the power transistor and the reference ground terminal in a forward-biased manner according to the detection voltage, so as to clamp a voltage swing of the detection voltage.

2. The buck power converter as recited in claim 1, wherein when the anti-ringing circuit calculates and determines a current flowing through the inductor has an absolute value smaller than a threshold value according to the detection voltage, the anti-ringing circuit provides the at least one second diode serially coupled between the second terminal of the power transistor and the reference ground terminal in the forward-biased manner.

3. The buck power converter as recited in claim 1, wherein when the anti-ringing circuit calculates and determines a current flowing through the inductor is equal to 0 according to the detection voltage, the anti-ringing circuit provides the at least one second diode serially coupled between the second terminal of the power transistor and the reference ground terminal in the forward-biased manner.

4. The buck power converter as recited in claim 1, wherein the anti-ringing circuit further comprises:
a switch, a first terminal of the switch being coupled to the second terminal of the power transistor, a second terminal of the switch being coupled to an anode of the at least one second diode, a control terminal of the switch receiving a control signal and being switched on or off according to the control signal; and
a control circuit coupled to the control terminal of the switch and the second terminal of the power transistor, the control circuit generating the control signal according to the detection voltage.

5. The buck power converter as recited in claim 4, wherein the control circuit calculates and determines whether a current flowing through the inductor has an absolute value smaller than a threshold value according to the detection voltage, so as to generate the control signal.

6. The buck power converter as recited in claim 5, wherein when the control circuit calculates and determines the current flowing through the inductor has the absolute value smaller than the threshold value according to the detection voltage, the control circuit generates the control signal to switch on the switch.

7. The buck power converter as recited in claim 1, further comprising:
a voltage regulating capacitor serially coupled between an output terminal of the power transistor and the reference ground terminal.
